(19) United States
(12) Patent Application Publication
(10) Pub. No.: US 2015/0159763 A1
(43) Pub. Date: Jun. 11, 2015

(54) METHOD OF MAKING A BALL VALVE

(71) Applicant: SHERWOOD VALVE LLC, Washington, PA (US)

(72) Inventor: Kent Alan Miller, Washington, PA (US)

(73) Assignee: SHERWOOD VALVE LLC, Washington, PA (US)

(21) Appl. No.: 14/100,287

(22) Filed: Dec. 9, 2013

(51) Int. Cl. F16K 5/06; B23K 9/167; B23P 15/00

(52) U.S. Cl. CPC F16K 5/0689; B23P 15/001; B23K 9/167

(57) ABSTRACT

A refrigeration valve having a ball valve assembly and a hermetic seal between the body and bonnet is provided. Such a refrigeration valve allows for a generally straight flow path for the associated fluid.

### BACKGROUND OF THE INVENTION

1. Field of the Invention

This application relates to a refrigeration valve and, more specifically, to a method of making a ball valve for an air conditioner/refrigerator having a ball valve member disposed within a hermetically sealed chamber.

2. Background Information

Refrigeration and air conditioners typically use an isolation valve having a stem-type shut-off mechanism and a flowpath with a ninety degree angle. Such valves are typically cast as a single, unitary body with the valve stem being the only major separate component. Such a unitary body is, essentially, leak proof, i.e. gases cannot escape through the body, and, as such, leaks typically only occur about the stem. While such valves are adequate, there is a pressure drop that occurs due to the angled flowpath. A valve having a generally straight flowpath would not have such a pressure drop and, therefore, would reduce the amount of time needed to charge refrigerant or pull a vacuum in a system.

Ball valves have a generally straight flowpath. Ball valves have a housing that defines a passage and a ball valve member disposed therein. The ball valve member is a metal sphere, e.g. steel, brass or other metals, having a central passage. Seals, typically made from PolyTetraFluoroEthylene (Teflon® by DuPont) or similar materials, are disposed between the ball valve and the chamber in which it is disposed. The ball rotates between a first, closed position, wherein the ball valve member central passage is not aligned with, nor in fluid communication with, the housing passage and a second position, wherein the ball valve member central passage is aligned with, and in fluid communication with, the housing passage. A handle assembly has an external handle and a stem. The stem has a first, inner end coupled to the ball valve member and a second, outer end that is coupled to the handle, allowing for rotation of the ball valve member. There are seals disposed about the stem as well.

A ball valve housing for an air conditioner/refrigerator typically includes a copper inlet tube, a brass fitting assembly, and a copper outlet tube. The brass fitting assembly is structured to support and sealingly engage the ball valve member seals and the stem seals. The brass fitting has two portions, a body and a bonnet. These portions define a ball chamber, in which the ball valve member is disposed. The body and bonnet are joined together by a threaded coupling. It is noted that, as the body and bonnet are threaded together, seals disposed between the ball and the brass fitting assembly are compressed into a sealing engagement with the ball valve member. The brass fitting assembly also includes an inlet port and an outlet port. The copper inlet tube is brazed to the inlet port. The copper outlet tube is brazed to the outlet port. The distal ends of the copper inlet tube and the copper outlet tube are structured to be coupled to the fluid system for an air conditioner/refrigerator. In this configuration, the brass fitting assembly has a potential leak path at the interface between the body and the bonnet.

It would be advantageous to have a ball valve with a straight flow path that is hermetically sealed. It is known that welding/brazing creates a hermetic seal. Such a method of construction for a ball valve, however, would require the valve member to be in situ during the welding/brazing. The valve member seals would be damaged by the temperatures associated with such welding/brazing.

There is, therefore, a need for a ball valve having a hermetic seal between the body and bonnet.

### SUMMARY OF THE INVENTION

The disclosed and claimed concept provides for a service ball valve assembly and a method of making the ball valve assembly having a hermetic seal between the body and bonnet. As used herein, a “service” valve includes an external connection whereby a service line may be attached thereto. The ball valve assembly is sized for use with household refrigerators and air conditioners. That is, the ball valve assembly, in an exemplary embodiment, has a passage diameter of about 0.318 in. diameter. The ball valve assembly is, in an exemplary embodiment, made from brass. It is noted that, for large, commercial and/or industrial refrigeration and air conditioning units, it is known to use large ball valves which may be sealed by welds. As used herein, a “large” ball valve has a passage that is greater than 0.49999 inch in diameter. “Large” ball valves are used as system valves, i.e. valves that are integral to the cooling circuit and do not have a external connection. Such large ball valves are manufactured by different methods than retail sized refrigeration valve assemblies and used in very different environments. Therefore, as used herein, “refrigeration ball valve” means a relatively small valve assembly sized for use on refrigerators/air conditioners and does not include large ball valves used for commercial and/or industrial sized refrigeration and air conditioning units.

The method of making the ball valve includes the steps of providing refrigeration ball valve fitting components including a body, a bonnet, and a ball valve member and a seal, wherein the fitting body defines a ball valve chamber and the ball valve member seals are disposed between the fitting body ball valve chamber and the ball valve member; then, positioning the ball valve member and ball valve member seals in the fitting body ball valve chamber, coupling the fitting body and the fitting bonnet at a circular interface, and, coupling the fitting body and the fitting bonnet by a metal coupling.

It is noted that the method is accomplished by limiting the seals exposure to heat. As such, the dimensions of the elements, e.g. the distance between the metal coupling and the seals, as well as the time it takes to create the metal coupling is important.

### BRIEF DESCRIPTION OF THE DRAWINGS

A full understanding of the invention can be gained from the following description of the preferred embodiments when read in conjunction with the accompanying drawings in which:

FIG. 1 is a side view of a refrigeration valve.

FIG. 2 is a cross-sectional view of a refrigeration valve.

FIG. 3 is a flow chart of the method steps.

FIG. 4 is a schematic side view of a heat absorbing support.

FIG. 5 is a schematic side view of a support with a cooling fluid apparatus.

### DESCRIPTION OF THE PREFERRED EMBODIMENTS

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the statement that two or more parts or components “engage” one another shall mean that the elements exert a force or bias against one another either directly or through one or more intermediate elements or components.

As used herein, the word “unitary” means a component is created as a single piece or unit. That is, a component that includes pieces that are created separately and which are then coupled together as a unit is not a “unitary” component or body.

As used herein, the term “number” shall mean one or an integer greater than one (i.e., a plurality).

As used herein, a “coupling assembly” includes two or more couplings or coupling components. The components of a coupling or coupling assembly are generally not part of the same element or other component. As such, the components of a “coupling assembly” may not be described at the same time in the following description.

As used herein, a “coupling” or “coupling component(s)” is one or more component(s) of a coupling assembly. That is, a coupling assembly includes at least two components that are structured to be coupled together. It is understood that the components of a coupling assembly are compatible with each other. For example, in a coupling assembly, if one coupling component is a snap socket, the other coupling component is a snap plug, or, if one coupling component is a bolt, then the other coupling component is a nut.

As used herein, “associated” means that the elements are part of the same assembly and/or operate together, or, act upon/with each other in some manner. For example, an automobile has four tires and four hub caps. While all the elements are coupled as part of the automobile, it is understood that each hubcap is “associated” with a specific tire.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are said to fit “snugly” together or “snuggly correspond.” In that situation, the difference between the size of the components is even smaller whereby the amount of friction increases. If the element defining the opening and/or the component inserted into the opening are made from a deformable or compressible material, the opening may even be slightly smaller than the component being inserted into the opening. This definition is further modified if the two components are said to “substantially correspond.” “Substantially correspond” means that the size of the opening is very close to the size of the element inserted therein; that is, not so close as to cause substantial friction, as with a snug fit, but with more contact and friction than a “corresponding fit,” i.e., a “slightly larger” fit. Further, as used herein, “loosely correspond” means that a slot or opening is sized to be larger than an element disposed therein. This means that the increased size of the slot or opening is intentional and is more than a manufacturing tolerance. Further, with regard to a surface formed by two or more elements, a “corresponding” shape means that surface features, e.g. curvature, are similar.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies.

As used herein, “at” means on or near.

As used herein, a “metal coupling” is a coupling created by a high temperature process such as brazing or welding. It is noted that, as used herein, a coupling created at a lower temperature, such as by soldering, is not a “metal coupling.”

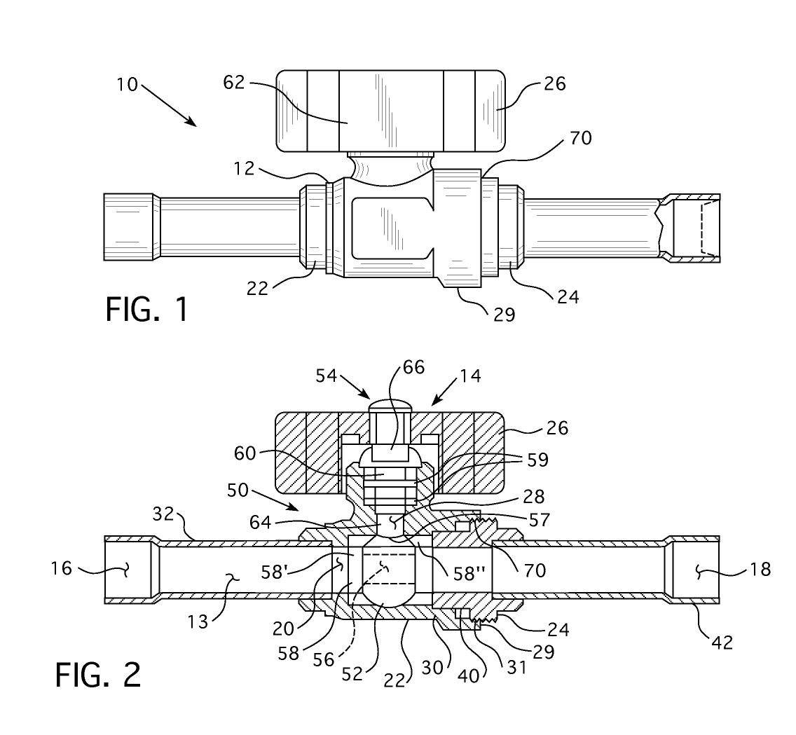

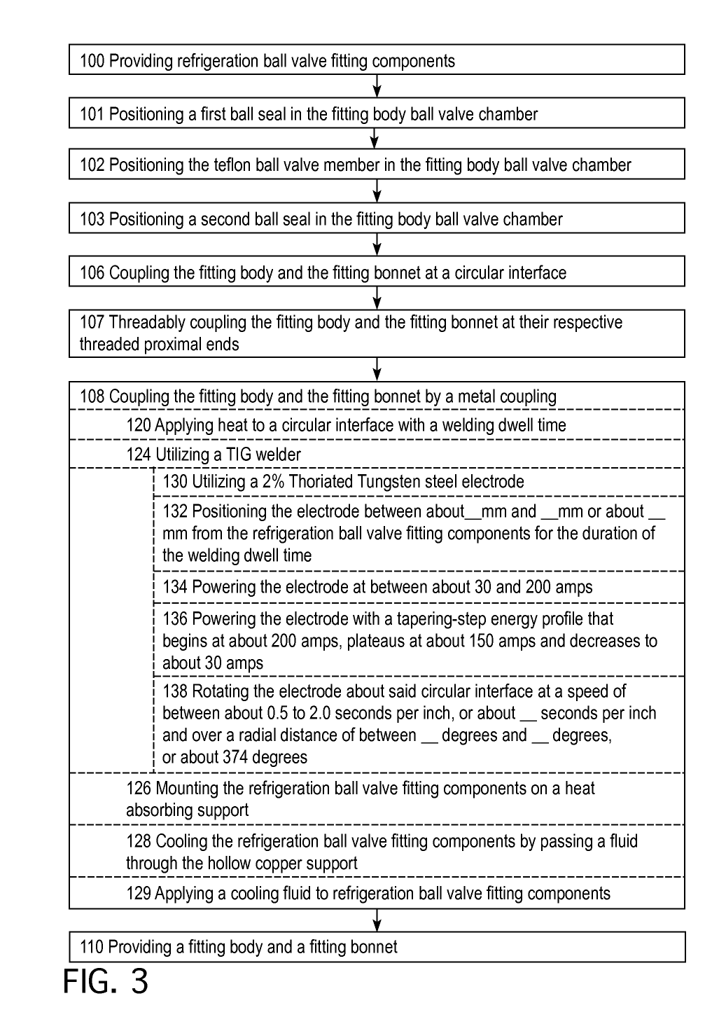

As shown in FIG. 1, a refrigeration valve 10 includes a fitting 12 and a valve assembly 14. The fitting 12 defines an elongated passage 13 (FIG. 2) having an inlet 16 and an outlet 18. The passage 13 has a cross-sectional area of between about 0.049 and 0.076 square inch, or about 0.0625 square inch. In an exemplary embodiment, the passage 13 is generally circular and has a diameter of between about 0.25 inch and 0.35 inch or about 0.312 inch. The fitting 12 also defines a ball valve chamber 20 disposed between the inlet 16 and the outlet 18. The fitting 12 is, in an exemplary embodiment, made from brass, copper or stainless steel. The fitting 12 includes a body 22, a bonnet 24, and a handle assembly 26. As shown in FIG. 2, the fitting body 22 includes the inlet 16 and the ball valve chamber 20 as well as a stem passage 28 and an outlet collar 29. More specifically, the fitting body 22 has a proximal end 30 and a distal end 32. The fitting body distal end 32 is the inlet 16. As described below, the bonnet 24 is coupled to the fitting body outlet collar 29 and is the outlet 18. In an exemplary embodiment, the inlet 16 and the outlet 18 are each elongated and substantially disposed about the same axis. The ball valve chamber 20 is disposed between the fitting body distal end 32 and the fitting body proximal end 30. The fitting body proximal end 30, i.e. outlet collar 29, in an exemplary embodiment, has a generally circular shape as well as inner threads 34. The stem passage 28 extends from outside the fitting body 22 into the ball valve chamber 20. The stem passage 28 extends generally perpendicular to the longitudinal axis of the passage 13.

In an exemplary embodiment, the ball valve chamber 20 has a sidewall thickness of between about 0.05 and 0.75 inch, or about 0.63 inch. The ball valve chamber 20 has an inner diameter of between about 0.4 and 0.6 inch, or about 0.515 inch. The outlet collar 29 has a length of between about 0.15 inch and 0.35 inch, or about 0.245 inch. In this configuration, and as described below, the bonnet 24 is coupled to the outlet collar 29 at a circular interface 31. Further, when the ball valve member 52, discussed below, is disposed in the ball valve chamber 20, the circular interface 31 is spaced between about 0.34 inch and 0.54 inch, or about 0.44 inch, from the outer surface of the ball seal 58, discussed below, adjacent the circular interface 31.

The bonnet 24 is an elongated, tubular member having a proximal end 40 and a distal end 42. The bonnet proximal end 40 has a generally circular shape as well as outer threads 44. The bonnet proximal end 40 and the fitting body proximal end 30 are structured to be coupled together by the threaded portions 34, 44. The interface of the bonnet proximal end 40 and the fitting body proximal end 30 closest to the ball valve chamber 20 defines the circular interface 31. The bonnet distal end 42 is a circular fitting selected from the group consisting of: hose barbs, flare by flare, flare by swivel flare, tube to tube, and flare by non-swivel flare.

The valve assembly 14 is, in an exemplary embodiment, a ball valve assembly 50 having a ball valve member 52 and a seal assembly 54. The ball valve member 52 is a substantially smooth sphere having a central passage 56. The ball valve member 52 is sized to correspond to the inner diameter of the ball valve chamber 20. In one embodiment, the ball valve member central passage 56 is, in an exemplary embodiment, sized to correspond to the size of the passage 13, as discussed above. That is, the ball valve member central passage 56 has a cross-sectional area of between about 0.049 and 0.076 square inch, or about 0.625 square inch. In an exemplary embodiment, the passage 13 is generally circular and has a diameter of between about 0.25 inch and 0.35 inch or about 0.312 inch. In another embodiment, the ball valve member central passage 56 has a diameter of between about 0.23 inch and 0.33 inch, or about 0.28 inch. In this configuration, the interface between the surface of the ball valve member central passage 56 and the ball seal(s) 58, discussed below, is greater than in the prior embodiment. The ball valve member 52 may also include a slot 57 cut into the external surface. In an exemplary embodiment, the slot 57 extends, generally, parallel to the ball valve member central passage 56.

The seal assembly 54 includes a number of ball seals 58 and a number of stem seals 59. In an exemplary embodiment there are at least two ball seals 58, a first ball seal 58′ and a second ball seal 58″, and at least one stem seal 59. The ball seals 58 are disposed between the ball valve member 52 and the fitting 12. As used herein, the “outer surface” of the ball seals 58 is the surface disposed away from the ball valve member 52. Each ball seal 58 is a torus. In an exemplary embodiment, the ball seals 58 are made from one of PTFE, also known as Teflon® by DuPont, TFM™ by Dyneon™ a 3M Company with 25% carbon filler, or TFM™ Virgin by Dyneon™ a 3M Company. When each ball seal 58 is installed, the central opening is aligned with the fitting passage 13. It is noted that, during assembly, the first ball seal 58 is initially installed within the ball valve chamber 20. Next, the ball valve member 52 is installed, thereby trapping the first ball seal 58 between the ball valve member 52 and the fitting body 22. The second ball seal 58 is then installed within the ball valve chamber 20. The fitting body 22 and the fitting bonnet 24 are then coupled by the threaded proximal ends 30, 40. As the fitting bonnet 24 is drawn toward the fitting body 22, the ball seals 58 are compressed between the fitting 12 and the ball valve member 52. That is, when the fitting body 22 and fitting bonnet 24 are threadably coupled, said ball valve assembly 50 is sealingly compressed within the fitting 12.

The handle assembly 26 includes a generally circular stem 60 and a handle member 62. The stem 60 has a first, inner end 64 and a second, outer end 66. The stem first end 64 is generally flat and sized to fit within the ball valve member slot 57. The stem second end 66 is structured to be fixed to the handle member 62. The at least one stem seal 59 is sized to extend about the stem 60.

When assembled, the ball valve member 52 is disposed in the ball valve chamber 20 as described above. Further, the ball valve member slot 57 is generally aligned with the fitting body stem passage 28. Thus, the stem 60 may be disposed within the stem passage 28 with the stem first end 64 disposed within the ball valve member slot 57. The at least one stem seal 59 is sealingly compressed between the stem 60 and the stem passage 28. It is noted that, as shown in the figures, there are three stem seals 59. The handle member 62 is fixed to the stem second end 66.

In this configuration, the valve assembly 14 is structured to move between a first, closed position, wherein a fluid is restricted from flowing from the inlet 16 to the outlet 18, and a second, open position, wherein a fluid is substantially free to flow from the inlet 16 to the outlet 18. It is further noted that, in this configuration, the passage 13, that is the passage extending through the fitting inlet 16, the fitting outlet 18 and the valve assembly 14 in the open position, defines a generally straight passage 13 for a fluid. In this configuration, the fluid passing through the refrigeration valve 10 does not suffer from a pressure drop as is common in valves having an angled flowpath.

The refrigeration valve 10 further includes an additional hermetic seal 70. That is, the fitting body 22 and fitting bonnet 24 are hermetically sealed by a metal coupling. The hermetic seal 70 is disposed at the exposed circular interface 31 of the fitting body 22 and the fitting bonnet 24 threaded proximal ends 30, 40. In this configuration, it is essentially impossible for fluid within the refrigeration valve 10 to escape at the fitting body 22/fitting bonnet 24 interface. Thus, for fluid to escape the refrigeration valve 10, the fluid would have to bypass at least one ball seal 58 and, in the embodiment shown, three stem seals 59.

In addition to the assembly steps noted above, the method of making a hermetically sealed refrigeration valve 10 includes the following steps. Initially, there is the step of providing 100 the refrigeration ball valve fitting 12 components including a body 22, a bonnet 24, a ball valve member 52, and a number of ball seals 58, wherein the fitting body 22 defines a ball valve chamber 20, and wherein the ball valve member 52 corresponds to the fitting body ball valve chamber 20. The method further includes, positioning 101 a first ball seal 58′ in the fitting body ball valve chamber 20, positioning 102 the ball valve member 52 in the fitting body ball valve chamber 20, positioning 103 a second ball seal in the fitting body ball valve chamber 20, coupling 106 the fitting body 22 and the fitting bonnet 24 at a circular interface 31, and then coupling 108 the fitting body 22 and the fitting bonnet 24 by a metal coupling. As noted above, the initial step of coupling 106 the fitting body 22 and the fitting bonnet 24 at a circular interface 31 is, in an exemplary embodiment, the step of threadably coupling 107 the fitting body 22 and the fitting bonnet 24 at their respective threaded proximal ends 30, 40.

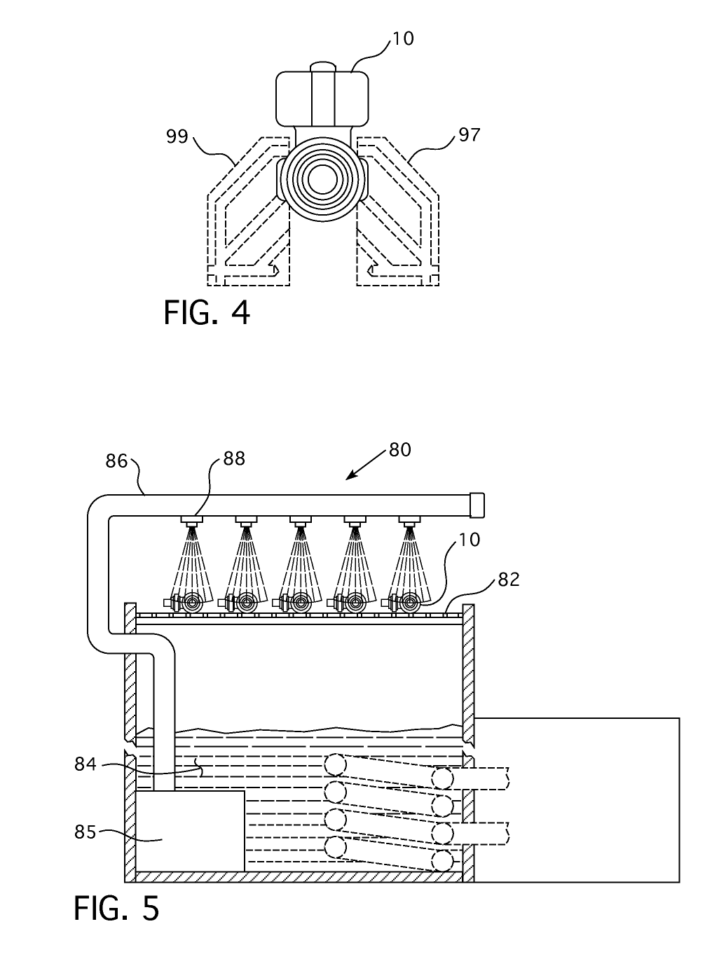

In an exemplary embodiment, and in view of the dimensions noted above, the step of providing 100 refrigeration ball valve fitting components includes the step of providing 110 a fitting body 22 and a fitting bonnet 24 structured to have a circular interface 31 spaced between 0.34 inch and 0.54 inch, or about 0.44 inch, from the outer surface of the second ball seal 58″, that is the ball seal 58 adjacent the circular interface 31. In an exemplary embodiment, the step of coupling 108 the fitting body 22 and the fitting bonnet 24 by a metal coupling includes utilizing a metal coupling with a number of specific characteristics. It is understood that any number of these steps can be utilized alone or in conjunction with each other. Accordingly, the step of coupling 108 the fitting body 22 and the fitting bonnet 24 by a metal coupling includes the step of applying 120 heat to the circular interface 31 with a welding dwell time of between about twelve and twenty-five seconds, or about eighteen seconds. In an exemplary embodiment, the welding is accomplished by tungsten inert gas welding (hereinafter “TIG welding”). Thus, the step of coupling 108 the fitting body 22 and the fitting bonnet 24 by a metal coupling includes the step of utilizing 124 a TIG welder (not shown). The step of coupling 108 the fitting body 22 and the fitting bonnet 24 by a metal coupling includes the step of mounting 126 the refrigeration ball valve fitting components on a heat absorbing support 99 (FIG. 4). In an exemplary embodiment, the heat absorbing support 99 is one of either a solid carbon steel support (not shown), a hollow copper support 97, or an aluminum support (not shown). A solid carbon steel support acts as a heat sink. Use of a hollow copper support 97 further allows for the step of cooling 128 the refrigeration ball valve fitting components by passing a fluid through the hollow copper support 97. In an exemplary embodiment, the cooling fluid is passed through the hollow copper support 97 for less than a minute to about 15 minutes after the application of heat, i.e. after the use of the TIG welder has ceased. The use of the cooling fluid is, however, optional.

In another exemplary embodiment, the step of mounting 126 the refrigeration ball valve fitting components on a heat absorbing support 99 includes the step of applying 129 a cooling fluid to the refrigeration ball valve fitting components. As shown in FIG. 5, and in an exemplary embodiment, the heat absorbing support 99 includes a cooling fluid apparatus 80 structured to spray a cooling fluid over the refrigeration ball valve fitting components. As is known, the cooling fluid apparatus 80 includes a support grate 82, a fluid reservoir 84, a pump 85, a number of fluid conduits 86 and a number of nozzles 88. In an exemplary embodiment, the cooling fluid apparatus 80 applies water at a temperature of between about 40° F. to 50° F., or about 45° F., and is sprayed on the refrigeration ball valve fitting components at a rate of between about 1.0 to 2.0 gal./min., or about 1.5 gal./min.

In an exemplary embodiment, the step of utilizing 124 a TIG welder further includes the steps of: utilizing 130 a 2% Thoriated Tungsten steel electrode (not shown), positioning 132 the electrode between about 0.0005 inch and 0.005 inch, or about 0.002 inch, from the refrigeration ball valve fitting components for the duration of the welding dwell time, and powering 134 the electrode at between about 30 and 200 amps. In an exemplary embodiment, energy is supplied to the electrode at a variable rate. As used herein, the amount of energy supplied over a period of time is an “energy profile.” In an exemplary embodiment, the energy profile for the energy is supplied to the electrode is a “tapering-step energy profile.” A “tapering-step energy profile” begins with a high energy that tapers briefly before becoming steady, i.e. plateauing, then tapering off again. In an exemplary embodiment, the step of utilizing 124 a TIG welder includes the step of powering 136 the electrode with a tapering-step energy profile that begins at about 200 amps, plateaus at about 150 amps, and decreases to about 30 amps. In an exemplary embodiment, the step of utilizing 124 a TIG welder includes the steps of rotating 138 the electrode about said circular interface at a speed of between about 6.0 to 12.5 seconds per inch, or about 9.0 seconds per inch, and, over a radial distance of between about 360 degrees and 390 degrees, or about 374 degrees.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A method of making a hermetically sealed refrigeration service ball valve comprising the steps of:
providing refrigeration ball valve fitting components including a body, a bonnet, a ball valve member, and a number of ball seals, said fitting body defining a ball valve chamber, said ball valve member corresponding to said fitting body ball valve chamber;
positioning a first ball seal in said fitting body ball valve chamber;
positioning said ball valve member in said fitting body ball valve chamber;
positioning a second ball seal in said fitting body ball valve chamber;
coupling said fitting body and said fitting bonnet at a circular interface; and
coupling said fitting body and said fitting bonnet by a metal coupling.

2. The method of claim 1 wherein said step of providing refrigeration ball valve fitting components includes the step of providing a fitting body and a fitting bonnet structured to have a circular interface spaced between about 0.34 and 0.54 from the outer surface of said second ball seal when said second ball seal is disposed in said fitting body ball valve chamber.

3. The method of claim 2 wherein said step of providing refrigeration ball valve fitting components includes the step of providing a fitting body and a fitting bonnet structured to have a circular interface spaced about 0.44 from the outer surface of said second ball seal when said second ball seal is disposed in said fitting body ball valve chamber.

4. The method of claim 3 wherein said step of coupling said fitting body and said fitting bonnet by a metal coupling includes the step of applying heat to said circular interface with a welding dwell time of about eighteen seconds.

5. The method of claim 4 wherein said step of coupling said fitting body and said fitting bonnet by a metal coupling includes the step of utilizing a TIG welder.

6. The method of claim 5 wherein said step of utilizing a TIG welder includes the steps of:
utilizing a 2% Thoriated Tungsten steel electrode;
positioning the electrode between about 0.0005 inch and 0.005 inch from said refrigeration ball valve fitting components for the duration of the welding dwell time; and
powering the electrode at between about 30 and 200 amps.

7. The method of claim 6 wherein said step of utilizing a TIG welder includes the step of positioning the electrode about 0.002 inch from said refrigeration ball valve fitting components for the duration of the welding dwell time.

8. The method of claim 6 wherein said step of utilizing a TIG welder includes the step of powering the electrode with a tapering-step energy profile that begins at about 200 amps, plateaus at about 150 amps, and decreases to about 30 amps.

9. The method of claim 6 wherein said step of utilizing a TIG welder includes the steps of:
rotating the electrode about said circular interface at a speed of between about 6.0 to 12.5 seconds per inch; and
rotating the electrode over a radial distance of between about 360 degrees and 390 degrees.

10. The method of claim 9 wherein said step of utilizing a TIG welder includes the steps of:
rotating the electrode about said circular interface at a speed of about 9.0 seconds per inch; and
rotating the electrode over a radial distance of about 374 degrees.

11. The method of claim 9 wherein said step of utilizing a TIG welder includes the step of powering the electrode with a tapering-step energy profile that begins at about 200 amps, plateaus at about 150 amps, and decreases to about 30 amps.

12. The method of claim 1 wherein said step of coupling said fitting body and said fitting bonnet by a metal coupling includes the step of mounting said refrigeration ball valve fitting components on a heat absorbing support.

13. The method of claim 12 wherein said heat absorbing support is one of either a solid carbon steel support, a hollow copper support, or an aluminum support.

14. The method of claim 12 wherein said heat absorbing support includes a cooling fluid apparatus and wherein said step of mounting the refrigeration ball valve fitting components on a heat absorbing support includes the step of applying a cooling fluid to the refrigeration ball valve fitting components.

15. The method of claim 1 wherein said step of coupling said fitting body and said fitting bonnet by a metal coupling includes the steps of:
mounting said refrigeration ball valve fitting components on a hollow copper support; and
cooling said refrigeration ball valve fitting components by passing a fluid through said hollow copper support.

16. The method of claim 1 wherein said step of coupling said fitting body and said fitting bonnet by a metal coupling includes the steps of:
mounting said refrigeration ball valve fitting components on a hollow copper support;
utilizing a TIG welder;
cooling said refrigeration ball valve fitting components by passing a fluid through said hollow copper support during the use of said TIG welder; and
cooling said refrigeration ball valve fitting components by passing a fluid through said hollow copper support for about 15 minutes after use of said TIG welder has ceased.

17. A refrigeration service valve comprising:
a fitting having an inlet and an outlet;
said fitting includes a body, a bonnet, and a handle assembly;
said fitting body defining a ball valve chamber, a stem passage, an inlet, and an outlet collar;
said ball valve chamber having an inner diameter of between about 0.4 and 0.75 inch;
said outlet collar having a length of between about 0.15 inch and 0.35 inch;
said fitting bonnet defining a passage and having an outlet, said fitting bonnet structured to be coupled to said fitting body;
a ball valve assembly structured to be disposed in said ball valve chamber, said ball valve assembly including a ball valve member and a seal assembly;
said ball valve member including a substantially spherical body defining a radial passage;
said ball valve member disposed in said ball valve chamber and structured to move between a first, closed position, wherein a fluid is restricted from flowing from said inlet to said outlet, and a second, open position, wherein a fluid is substantially free to flow from said inlet to said outlet;
said seal assembly including a number of ball seals, said ball seals disposed in said ball valve chamber;
said fitting bonnet coupled to said outlet collar at a circular interface;
said circular interface spaced between 0.34 inch and 0.54 inch from the outer surface of the ball seal adjacent said circular interface; and
wherein said fitting body and fitting bonnet are hermetically sealed by a metal coupling.

18. The refrigeration valve of claim 17 wherein:
said fitting body having a diameter of about 0.515 inch;
said outlet collar having a length of about 0.245 inch; and
said circular interface disposed about 0.44 inch, from the outer surface of the ball seal adjacent the circular interface.

19. The refrigeration valve of claim 17 wherein said fitting body and fitting bonnet are made from a material selected from the group including: brass, copper, or stainless steel.

20. The refrigeration valve of claim 16 wherein said ball seals are made from one of PTFE, TFM with 25% carbon filler, or TFM Virgin.
